(19) United States
(12) Patent Application Publication
(10) Pub. No.: US 2015/0039434 A1
(43) Pub. Date: Feb. 5, 2015

(54) ESTABLISHING COMMUNICATION WITH A COMPUTING DEVICE BASED ON THE PROXIMITY OF THE COMPUTING DEVICE TO A LOCATION

(71) Applicant: Digtal Capital AG, Zug (CH)

(72) Inventors: Artem Golubchenko, Ruvigliana (CH); William Todd Tribell, Tallinn (EE); Stewart Eugene Kosoy, Encino, CA (US); Edward del Castillo, La Canada, CA (US); Holly Newman, Studio City, CA (US)

(21) Appl. No.: 14/451,387

(22) Filed: Aug. 4, 2014

Related U.S. Application Data
(60) Provisional application No. 61/861,929, filed on Aug. 2, 2013.

(51) Int. Cl. G06Q 30/02

(52) U.S. Cl. CPC G06Q 30/0261; G06Q 30/0258
USPC 705/14.56; 705/14.58

(57) ABSTRACT

The disclosed embodiment relates to establishing communication with a nearby user computing device. An exemplary method executed by one or more computing devices comprises monitoring a geographic area to determine whether a user computing device is located within the proximity of at least one of the one or more computing devices, and when the user computing device is located within the proximity of at least one of the one or more computing devices, identifying, by at least one of the one or more computing devices, the user computing device based on identifying information associated with the user computing device. The method preferably further comprises transmitting promotional information to the user computing device, the promotional information being based at least in part on the identity of the user computing device and the geographic location of the user computing device.

### RELATED APPLICATION DATA

This application claims priority to U.S. Provisional Patent Application No. 61/861,929, filed Aug. 2, 2013, the disclosure of which is incorporated by reference in its entirety.

### FIELD OF THE INVENTION

The invention relates to establishing communication with a computing device based on the proximity of the computing device to a location.

### SUMMARY

The disclosed embodiment relates establishing communication with a nearby user computing device. An exemplary method executed by one or more computing devices comprises monitoring a geographic area to determine whether a user computing device is located within the proximity of at least one of the one or more computing devices, and when the user computing device is located within the proximity of at least one of the one or more computing devices, identifying, by at least one of the one or more computing devices, the user computing device based on identifying information associated with the user computing device. The method preferably further comprises transmitting promotional information to the user computing device, the promotional information being based at least in part on the identity of the user computing device and the geographic location of the user computing device. The method may further include receiving response information from the user computing device in response to the promotional information.

As disclosed herein, the identifying information associated with the user computing device may include registration information corresponding to a user associated with the user computing device, at least one of the one of more computing devices may be associated with a provider of products or services, and the promotional information may include information associated with at least one of the products or services. Furthermore, the identifying information associated with the user computing device may be stored in a remote storage.

An exemplary apparatus may include one or more processors and one or more memories operatively coupled to at least one of the one or more processors and having instructions stored thereon that, when executed by at least one of the one or more processors, cause at least one of the one or more processors to carry out the disclosed methods.

Exemplary non-transitory computer-readable media may store computer-readable instructions that, when executed by one or more computing devices, cause at least one of the one or more computing devices to carry out the disclosed methods.

### BRIEF DESCRIPTION OF THE DRAWINGS

FIG. 1 illustrates an exemplary method according to the disclosed embodiment.

FIG. 2 illustrates an exemplary geographic area according to the disclosed embodiment.

FIG. 3 illustrates an exemplary computing device architecture according to the disclosed embodiment.

### DETAILED DESCRIPTION

The following is a description of the best method and system presently contemplated for carrying out the disclosed embodiment which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

The disclosed embodiment provides the ability to identify and communicate with a computing device based on its proximity to a specific location. This enables, for example, locating and communicating with computing devices associated with users to thereby target users and provide them with promotional information, for example, for advertising purposes, promoting products, facilitating retail sales for products or services, and the like. The terms “user”, “customer”, “consumer”, “client”, and the like are used interchangeably herein, and are intended to refer to any person who may be interested in products, services, etc.

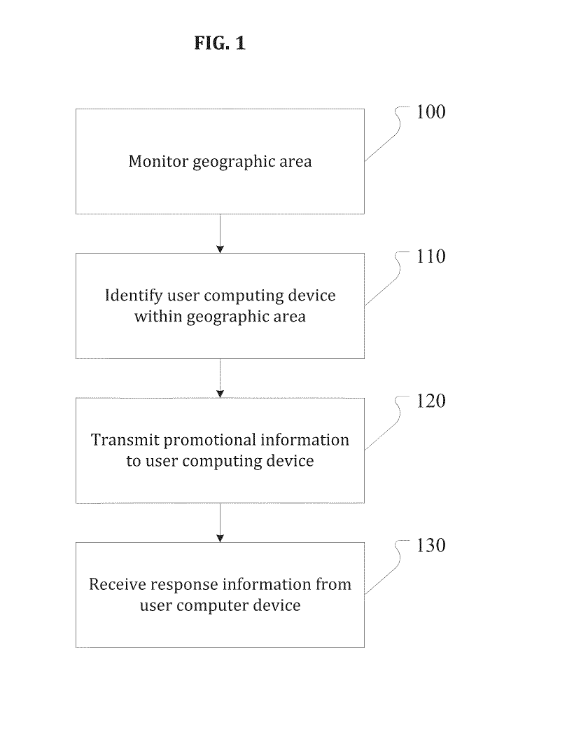

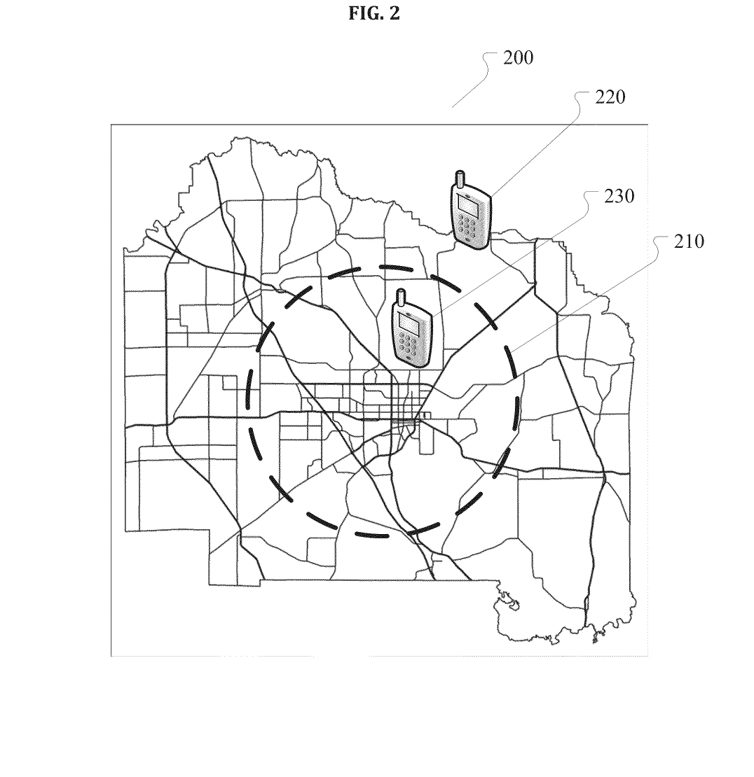

As shown in FIGS. 1 and 2, a geographic area can be electronically monitored in step 100. This monitoring functions to detect and identify user computing devices that are within the geographic area, and more specifically, within the proximity of a specific location. The geographic area disclosed herein can be of any size, for example, as large as a country or as specific as a street address. The monitoring can be executed by any suitable computing device, and the computing device may or may not itself be located within the monitored geographic area. For example, if the monitored geographic area is the area around a store in New York city, the computing device(s) executing the monitoring may be located within the store itself, or may instead be located in an entirely different location, such as a different city, state, or even country. In short, any computing device with the capability of monitoring the geographic area can do so.

For example, in FIG. 2, geographic area 210 is located within region 200. When geographic area 210 is being monitored according to the disclosed embodiment, user computing device 230 can be detected since it is located within geographic area 210. However, user computing device 220 may not be detected. In some cases, the location monitored may not be a specific area, but rather, an approximate area, for example, within 5 miles of geographic area 210. In this scenario, user computing device 220 may be detected if it falls within 5 miles of geographic area 210.

The monitoring and detection of user computing devices may utilize a database of identity information associated with known user computing devices and their associated users. The database may be a local database or may be stored remotely on a server, for example. The identifying information associated with the user computing device may include registration information corresponding to a user associated with the user computing device. For example, when a user registers with a particular website, that website may save the user's registration information and information that identifies that user's computing device in the database. The registration information may include, for example, the user's consumer preferences, interests, and activities either generally, or with regard to products or services offered on the website or by an affiliated entity.

Then, using the identifying information, the electronic monitoring of the geographic area can detect the user's computing device when it is within the geographic area. Typically a user will grant permission for their device to be detectable; however, the user computing device may be detected with or without permission of the user. This detection can be executed with any known means, for example, near field communication (NFC), RFID, permission-based cookies, an IP address associated with the user computing device, a Bluetooth connection with the user computing device, GPS tracking of the user computing device, proximity of the user computing device to a cell tower, presence of the user computing device on a nearby network, such as a Wi-Fi network, and the like.

When a user computing device is detected within the geographic area, or within the proximity of a specific location, the user computing device can be identified in step 110 based on the identifying information associated with the user computing device, for example, stored in the database or some other storage location.

After the user computing is identified, promotional information can be transmitted to the user computing device in step 120. The promotional information can be transmitted using any suitable technique including, for example, SMS, email, device notifications or alerts, and the like. The promotional information may be transmitted either by the computing device that monitored the geographic area or by any other computing device. For example, if the monitoring and detection of the user computing device is executed by a server-side computing device, a client-side computing device (e.g. associated with local products or services) may execute the transmission of the promotional information to the user computing device. In this scenario, the server-side computing device may notify the client-side computing device of the presence of the user computing device within the geographic area so that the client-side computing device can know to transmit promotional information to the user computing device or to take other action. The promotional information is preferably based at least in part on the identity of the user computing device, the geographic location of the user computing device, or other factors. This promotional information can include, for example, notifications, offers, advertisements, and the like, usually associated with products or services offered within the geographic area.

Response information can also be received in step 130 from the user computing device in response to the promotional information. For example, if the user is interested in something included in the promotional information, the response information can include an indication that the user will be visiting a local store or establishment, or that the user is interested in the noted products or services. In this manner, the response information can be used to meet the expectations of the user, for example, when the user arrives at a store or other location.

Thus, as described above, the disclosed embodiment enables any entity in the advertising, manufacturing, distribution, or retail process to collaborate using information associated with consumer preferences, interests, and activities to more completely and efficiently meet the needs of consumers by providing notifications, offers, advertisements, and the like to computing devices associated with consumers based on their geographic location.

Likewise, by receiving the promotional materials while located within a geographic area or within the proximity of a specific location, consumers can identify any entity in the advertising, manufacturing, distribution, or retail process associated with their preferences, interests, activities, and the like using their mobile devices based on their geographic location. Such consumers can utilize the features disclosed herein to locate any nearby entity in the advertising, manufacturing, distribution, or retail process to thereby identify and take advantage of any notifications, offers, advertisements, and the like based on their geographic location.

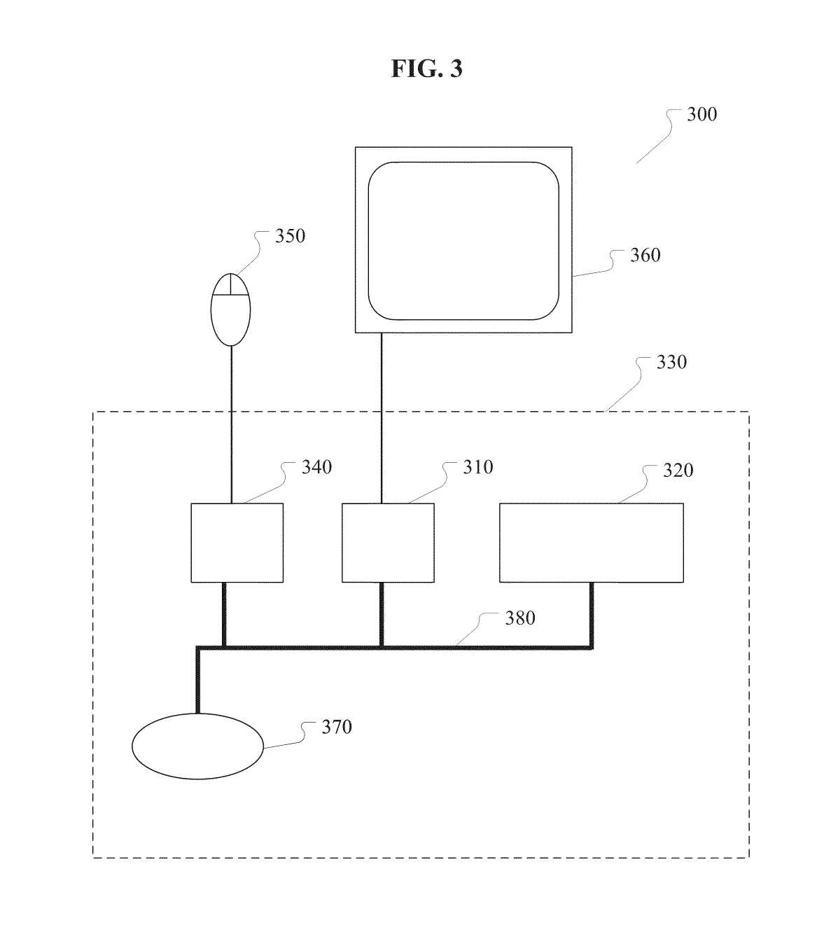

As described herein and in FIG. 3, any suitable server-side or client-side computing device can monitor the geographic areas described herein and transmit promotional material to a user computing device. In addition, any suitable server-side or client-side computing device can utilize previously acquired data associated with a user to target that user's computing device. By establishing communications between computing devices based on the geographic location of a user computing device, the needs and expectations of the user can be better met.

The initial “push” transmission from the monitoring computing device to the user computing device can be achieved using any known techniques, for example, automatically generated pre-defined and/or artificial intelligence triggers which allow the monitoring computing device to send a signal and/or communicate with the user computing device. The client can also reach out to the host to ‘seek’ criteria provided by the user. In this case, the host can provide a geographical co-ordinate as well as exchange any necessary personal data with the client.

The following example illustrates an exemplary implementation of the disclosed embodiment.

Suppose ‘Shoefactory’ is a large manufacturer of dozens of name brand shoes, and wishes to increase the opportunities to know who their clients are, better meet their clients' needs, and gain the ability to better manipulate their turnover. The features disclosed herein can be used to have better access to their customers and to potential customers. On the home page of each of Shoefactory's brands, the possibility exists for someone browsing to provide relevant information to allow their preferences and availability to be known to Shoefactory and the subsequent shops selling Shoefactory's products.

Suppose ‘Shoe Me’, a shoe retailer, wishes to have better access to both existing and potentially new customers. Thus, Shoe Me can also uses the features disclosed herein to better connect Shoe Me to both existing and potential customers.

Jane Doe is a regular customer of ‘Shoefactory’ and has registered herself on website of one of the brands of shoes manufactures by ‘Shoefactory’. The brand is ‘Exottica’, and, while on the website, Jane viewed three pair of shoes, one red, one white and one black.

Exottica, which also utilizes the features disclosed herein, pays attention to what Jane is interested in and already has information on file regarding her shoe size (8½) from her registration on their website. They also have registration information for her, such as her email address, and permission to contact her from time to time.

As part of her registration with Exottica's website, Jane had given Exottica permission to use the geographic location based services on her mobile device (e.g. an iPhone) for her convenience.

Jane was on a business trip to London two weeks later and happened to have some free time after a meeting. She decided to window shop on Bond Street where Shoe Me so happened to have a boutique.

Using the monitoring and detection aspects of the disclosed embodiment described herein, a computing device affiliated with Shoe Me detected Jane's mobile computing device as being was near Shoe Me's Bond Street boutique. Using the registration information Jane provided, as well as her preferences on file, the system also recognized that a pair of shoes that Jane was looking at on Exottica's website two weeks ago were in stock in the local Show Me's boutique.

After detecting Jane's mobile device, promotional information was sent to Jane's mobile device notifying Jane that only was the pair of shoes she was looking at on Exottica's website for sale at the Shoe Me, but also that Shoe Me had her size in stock. In addition, the system can send a notification, if necessary, to Shoe Me informing them that Jane is located in their proximity. This notification gives Shoe Me the information it needs to contact Jane directly and provide her with additional promotional information in the form of an offer (e.g. one of the staff who knew those shoes had been in the store for a long time decided to send Jane a message that she would receive a 20% discount if she were to purchase those shoes within the hour.)

Although Jane wasn't anticipating on buying those shoes and didn't even realize that the store was there, she couldn't resist the temptation to get a 20% discount and buy the shoes, so she used the promotional information that was provided and visited the local Shoe Me store.

Since Shoe Me had already been notified of Jane's proximity, they were also expecting her to arrive, and thus, they were can be ready to greet her with a more personal approach. Jane had a warm feeling from the moment she walked in the store. Since the store knew that Jane was a serious potential buyer for the red shoes, they really rolled out the red carpet for her. She felt like a celebrity.

Through the use of the features of the disclosed embodiment, a customer, Jane, was connected with a local retailer, Shoe Me, that she didn't even know was there. In addition, Shoe Me was able to make a sale to Jane and clear inventory that had been on their shelves for some time. The features of the disclosed embodiment further enabled a distributor, Exottica, to increase its sales by better serving the needs of its customers through the use of the technology (i.e. serving the specific needs of Jane).

Because she was provided with a unique and personal experience, Jane tells all her friends about how great her experience was, and she referred additional friends to Exottica's website and they registered for the same service. Other referred customers registered with the Shoe Me website. Thus, the connections established between the manufacturer, distributor, retailer, and consumer, and the related exchanges of information, resulted in an experience beneficial to all participants. Specifically, the features of the disclosed embodiment enabled the detection of Jane's proximity to a specific location and facilitated the communications to the benefit of all parties involved.

Exemplary Computing Environment

One or more of the above-described techniques can be implemented in or involve one or more computer systems. FIG. 3 illustrates a generalized example of a computing environment 300. The computing environment 300 is not intended to suggest any limitation as to scope of use or functionality of described embodiments.

With reference to FIG. 3, the computing environment 300 includes at least one processing unit 310 and memory 320. In FIG. 3, this most basic configuration 330 is included within a dashed line. The processing unit 310 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 320 stores software implementing described techniques.

A computing environment may have additional features. For example, the computing environment 300 includes storage 340, one or more input devices 350, one or more output devices 360, and one or more communication connections 370. An interconnection mechanism 380, such as a bus, controller, or network interconnects the components of the computing environment 300. Typically, operating system software (not shown) provides an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which can be used to store information and which can be accessed within the computing environment 300. In some embodiments, the storage 340 stores instructions for software.

The input device(s) 350 may be a touch input device such as a keyboard, mouse, pen, trackball, touch screen, or game controller, a voice input device, a scanning device, a digital camera, or another device that provides input to the computing environment 300. The output device(s) 360 may be a display, printer, speaker, or another device that provides output from the computing environment 300.

The communication connection(s) 370 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 300, computer-readable media include memory 320, storage 340, communication media, and combinations of any of the above.

Having described and illustrated the principles of the invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The description herein is presented to enable a person of ordinary skill in the art to make and use the invention and is provided in the context of the requirement for a obtaining a patent. The present description is the best presently-contemplated method for carrying out the disclosed embodiment. Various modifications to the disclosed embodiment will be readily apparent to those skilled in the art and the generic principles of the disclosed embodiment may be applied to other embodiments, and some features of the disclosed embodiment may be used without the corresponding use of other features. Accordingly, the disclosed embodiment is not intended to be limited to the embodiment shown but is to be accorded the widest scope consistent with the principles and features described herein.

What is claimed is:

1. A computer-implemented method executed by one or more computing devices for establishing communication with a nearby user computing device, the method comprising:
monitoring, by at least one of the one or more computing devices, a geographic area to determine whether a user computing device is located within the proximity of at least one of the one or more computing devices;
when the user computing device is located within the proximity of at least one of the one or more computing devices, identifying, by at least one of the one or more computing devices, the user computing device based on identifying information associated with the user computing device; and
transmitting, by at least one of the one or more computing devices, promotional information to the user computing device, the promotional information being based at least in part on the identity of the user computing device and the geographic location of the user computing device.

2. The method of claim 1, wherein the identifying information associated with the user computing device includes registration information corresponding to a user associated with the user computing device.

3. The method of claim 1, wherein at least one of the one of more computing devices is associated with a provider of products or services.

4. The method of claim 3, wherein the promotional information includes information associated with at least one of the products or services.

5. The method of claim 1, further comprising receiving response information from the user computing device in response to the promotional information.

6. The method of claim 1, wherein the identifying information associated with the user computing device is stored in a remote storage.

7. An apparatus for establishing communication with a nearby user computing device, the apparatus comprising:
one or more processors; and
one or more memories operatively coupled to at least one of the one or more processors and having instructions stored thereon that, when executed by at least one of the one or more processors, cause at least one of the one or more processors to:
monitor a geographic area to determine whether a user computing device external to the apparatus is located within the proximity of the apparatus;
when the computing device is located within the proximity of the apparatus, identify the user computing device based on identifying information associated with the user computing device; and
enable the transmission of promotional information to the user computing device, the promotional information being based at least in part on the identity of the user computing device and the geographic location of the user computing device.

8. The apparatus of claim 7, wherein the identifying information associated with the user computing device includes registration information corresponding to a user associated with the user computing device.

9. The apparatus of claim 7, wherein the apparatus is associated with a provider of products or services.

10. The apparatus of claim 9, wherein the promotional information includes information associated with at least one of the products or services.

11. The apparatus of claim 7, wherein at least one of the one or more memories has further instructions stored thereon that, when executed by at least one of the one or more processors, cause at least one of the one or more processors to enable the receipt of response information from the user computing device in response to the promotional information.

12. The apparatus of claim 7, wherein the identifying information associated with the user computing device is stored in a remote storage.

13. At least one non-transitory computer-readable medium storing computer-readable instructions that, when executed by one or more computing devices, cause at least one of the one or more computing devices to:
monitor a geographic area to determine whether a user computing device is located within the proximity of at least one of the one or more computing devices;
when the user computing device is located within the proximity of at least one of the one or more computing devices, identify the user computing device based on identifying information associated with the user computing device; and
transmit promotional information to the user computing device, the promotional information being based at least in part on the identity of the user computing device and the geographic location of the user computing device.

14. The at least one non-transitory computer-readable medium of claim 13, wherein the identifying information associated with the user computing device includes registration information corresponding to a user associated with the user computing device.

15. The at least one non-transitory computer-readable medium of claim 13, wherein at least one of the one or more computing devices is associated with a provider of products or services.

16. The at least one non-transitory computer-readable medium of claim 15, wherein the promotional information includes information associated with at least one of the products or services.

17. The at least one non-transitory computer-readable medium of claim 13, further storing instructions that, when executed by one or more computing devices, cause at least one of the one or more computing devices to receive response information from the user computing device in response to the promotional information.

18. The at least one non-transitory computer-readable medium of claim 13, wherein the identifying information associated with the user computing device is stored in a remote storage.
